(19) United States
(12) Patent Application Publication
(10) Pub. No.: US 2026/0052515 A1
(43) Pub. Date: Feb. 19, 2026

(54) LEADER-BASED TXOP REDISTRIBUTION PROCEDURE FOR P2P COMMUNICATION

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Yue Qi, Plano, TX (US); Vishnu Vardhan Ratnam, Frisco, TX (US); Bilal Sadiq, Plano, TX (US)

(21) Appl. No.: 19/279,847

(22) Filed: Jul. 24, 2025

Related U.S. Application Data
(60) Provisional application No. 63/682,624, filed on Aug. 13, 2024.
(60) Provisional application No. 63/691,164, filed on Sep. 5, 2024.
(60) Provisional application No. 63/695,212, filed on Sep. 16, 2024.

(51) Int. Cl. H04W 72/04; H04L 67/104

(52) U.S. Cl. CPC H04W 72/04; H04L 67/104

(57) ABSTRACT

A first station (STA) includes a transceiver configured to receive, from an access point (AP), a first trigger frame for a transmission opportunity (TXOP) allocation for a peer-to-peer (P2P) group that includes a plurality of STAs including the first STA, and in response to receipt of the first trigger frame, transmit, to the AP, a response frame. The first STA also includes a processor operably coupled to the transceiver. The processor is configured to allocate portions of the TXOP allocation among other STAs in the plurality of STAs included in the P2P group. The transceiver is further configured to transmit, to each of the other STAs allocated a portion of the TXOP allocation, a second trigger frame indicating the allocated portion of the TXOP allocation.

### CROSS-REFERENCE TO RELATED APPLICATION(S) AND CLAIM OF PRIORITY

This application claims priority under 35 U.S.C. § 119 (e) to U.S. Provisional Patent Application No. 63/682,624 filed on Aug. 13, 2024, U.S. Provisional Patent Application No. 63/691,164 filed on Sep. 5, 2024, and U.S. Provisional Patent Application No. 63/695,212 filed on Sep. 16, 2024. The above-identified provisional patent applications are hereby incorporated by reference in their entirety.

### TECHNICAL FIELD

This disclosure relates generally to wireless networks. More specifically, this disclosure relates to leader-based transmission opportunity (TXOP) redistribution procedures for peer-to-peer (P2P) communication.

### BACKGROUND

Wireless Local Area Network (WLAN) technology allows devices to access the internet in the 2.4 GHz, 5 GHZ, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

### SUMMARY

This disclosure provides apparatuses and methods for leader-based TXOP redistribution in P2P communications.

In one embodiment, a first station (STA) is provided. The first STA includes a transceiver configured to receive, from an access point (AP), a first trigger frame for a transmission opportunity (TXOP) allocation for a peer-to-peer (P2P) group that includes a plurality of STAs including the first STA, and in response to receipt of the first trigger frame, transmit, to the AP, a response frame. The first STA also includes a processor operably coupled to the transceiver. The processor is configured to allocate portions of the TXOP allocation among other STAs in the plurality of STAs included in the P2P group. The transceiver is further configured to transmit, to each of the other STAs allocated a portion of the TXOP allocation, a second trigger frame indicating the allocated portion of the TXOP allocation.

In another embodiment, an AP is provided. The AP includes a processor, and a transceiver operably coupled to the processor. The transceiver is configured to transmit a first trigger frame for a TXOP allocation for a P2P group that includes a plurality of STAs including a first STA, and in response to transmission of the first trigger frame, receive a response frame from the first STA.

In yet another embodiment, a second STA is provided. The second STA includes a processor, and a transceiver operably coupled to the processor. The transceiver is configured to receive, from an AP, a first trigger frame for a TXOP allocation for a P2P group that includes a plurality of STAs including a first STA and the second STA, and receive, from the first STA, a second trigger frame indicating a portion of the TXOP allocated by the first STA to the second STA.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The following documents and standards descriptions are hereby incorporated into the present disclosure as if fully set forth herein: [1] IEEE P802.11be-D6.0 “Part 11: Wireless LAN Medium Access Control (MAC) and Physical Layer (PHY) Specifications—Amendment 8: Enhancements for extremely high throughput (EHT)”; and [2] IEEE P802.11 REVme Draft D6.0 “Part 11: Wireless LAN Medium Access Control (MAC) and Physical Layer (PHY) Specifications”.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example wireless network where infrastructure traffic and non-infrastructure traffic coexist according to embodiments of the present disclosure;

FIG. 4 illustrates an example of an unavailability indication of a first STA to an AP due to a scheduled P2P communication with a second STA according to embodiments of the present disclosure;

FIG. 5 illustrates an example of an unavailability indication of a first STA to an AP due to a scheduled coex event with a second STA according to embodiments of the present disclosure;

FIG. 6 illustrates an example format of a QoS-aware unavailability indication option as a mode of P2P TWT unavailability according to embodiments of the present disclosure;

FIG. 7A illustrates an example format of a channel usage request frame including a QoS information element according to embodiments of the present disclosure;

FIG. 7B illustrates an example format of a channel usage response frame including a QoS information element according to embodiments of the present disclosure;

FIG. 8 illustrates an example of an unavailability schedule or P2P TWT SPs according to embodiments of the present disclosure;

FIG. 9 illustrates an example of a TXOP allocation to a P2P group according to embodiments of the present disclosure;

FIG. 10 illustrates an example of a TXOP distribution by a P2P group leader according to embodiments of the present disclosure;

FIG. 11 illustrates an example of a redistribution of a TXOP received from an AP according to embodiments of the present disclosure;

FIG. 12 illustrates an example AP side procedure for redistribution of a TXOP according to embodiments of the present disclosure;

FIG. 13 illustrates an example P2P group leader side procedure for redistribution of a TXOP according to embodiments of the present disclosure;

FIG. 14 illustrates an example format of a QoS information element that includes an AC value according to embodiments of the present disclosure;

FIG. 15 illustrates an example of STA availability during a P2P TWT SP due to the reception of a frame for an indicated AC according to embodiments of the present disclosure;

FIG. 16 illustrates example format of a QoS information element that includes a list of AC values according to embodiments of the present disclosure;

FIG. 17 illustrates example format of a QoS information element that includes an AC bitmap according to embodiments of the present disclosure;

FIG. 18 illustrates an example of STA availability for receiving a frame corresponding to an AC listed in a QoS information element according to embodiments of the present disclosure;

FIG. 19 illustrates another example of STA availability for receiving a frame corresponding to an AC listed in a QoS information element according to embodiments of the present disclosure;

FIG. 20 illustrates an example format of a QoS information element that includes an AC value according to embodiments of the present disclosure;

FIG. 21 illustrates an example of STA availability during a P2P TWT SP due to the reception of a frame for an indicated R-TWT schedule according to embodiments of the present disclosure;

FIG. 22 illustrates an example of STA availability for receiving a frame corresponding to an R-TWT schedule listed in a QoS information element according to embodiments of the present disclosure;

FIG. 23 illustrates an example of STA availability for receiving a frame corresponding to an R-TWT SP listed in a QoS information element according to embodiments of the present disclosure;

FIG. 24 illustrates an example method for leader-based TXOP redistribution in P2P communications according to embodiments of the present disclosure;

FIG. 25 illustrates another example method for leader-based TXOP redistribution in P2P communications according to embodiments of the present disclosure; and

FIG. 26 illustrates another example method for leader-based TXOP redistribution in P2P communications according to embodiments of the present disclosure.

### DETAILED DESCRIPTION

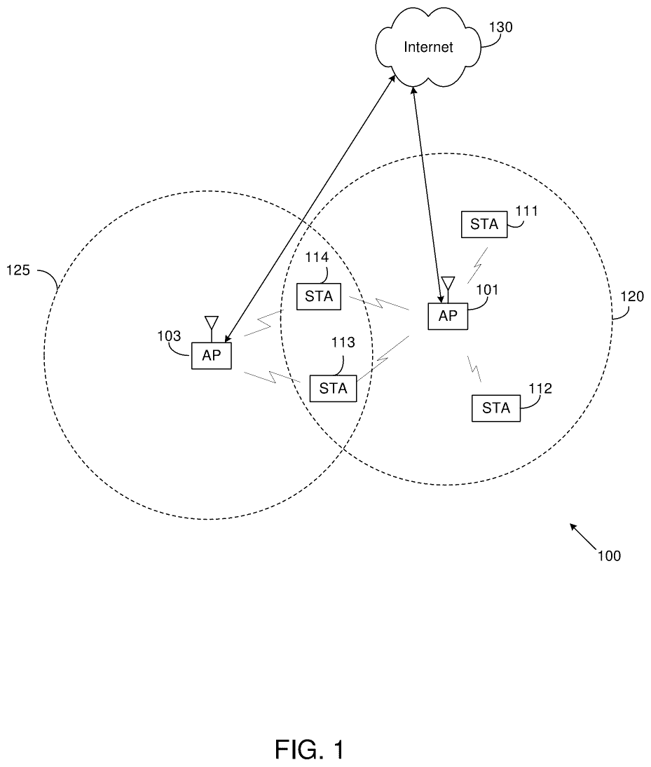

FIGS. 1 through 26, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Existing WLAN standards support multiple bands of operation, where an access point (AP) and a non-AP device may communicate with each other, called links. Thus, both the AP and non-AP device may be capable of communicating on different bands/links, which is referred to as mutli-link operation (MLO). Devices capable of such MLO are referred to as multi-link devices (MLDs).

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating multi-link adaptation based on network quality monitoring. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

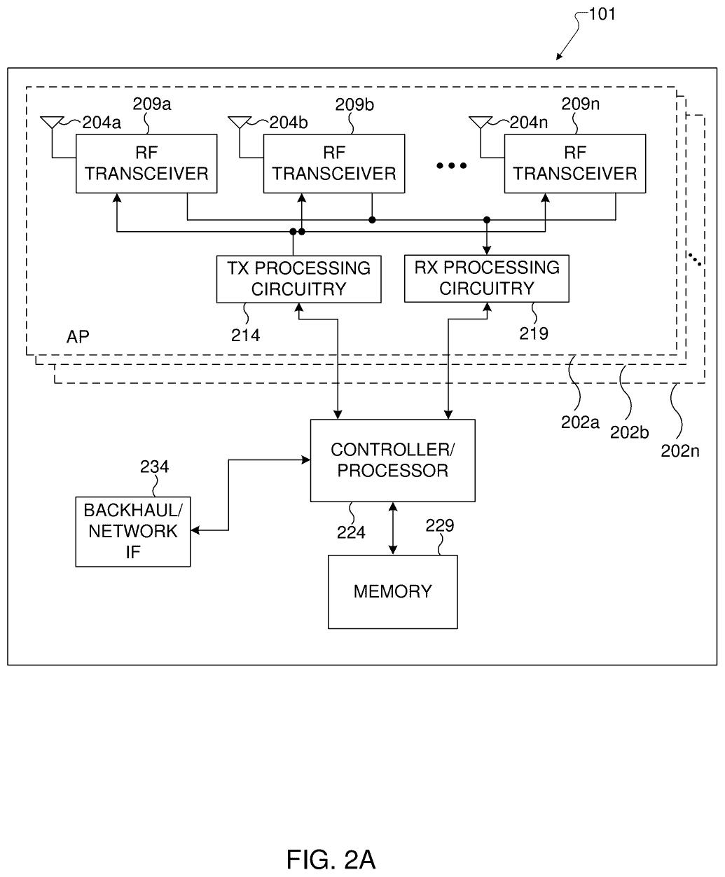

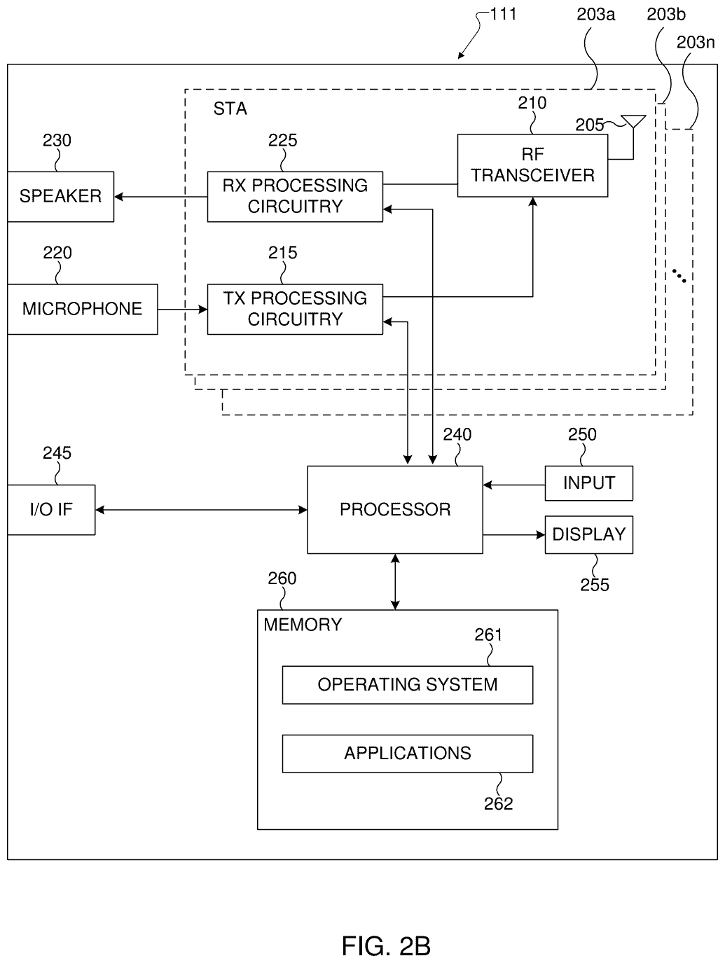

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP MLD 101 by the controller/processor 224 including facilitating multi-link adaptation based on network quality monitoring. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating multi-link adaptation based on network quality monitoring. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHZ, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate EMLMR operations for MLDs in WLANs. In some embodiments, the controller/processor 240 includes at least one microprocessor or microcontroller.

The controller/processor 240 is also capable of executing other processes and programs resident in the memory 260, such as operations for facilitating multi-link adaptation based on network quality monitoring. The controller/processor 240 can move data into or out of the memory 260 as required by an executing process. In some embodiments, the controller/processor 240 is configured to execute a plurality of applications 262, such as applications for facilitating multi-link adaptation based on network quality monitoring. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

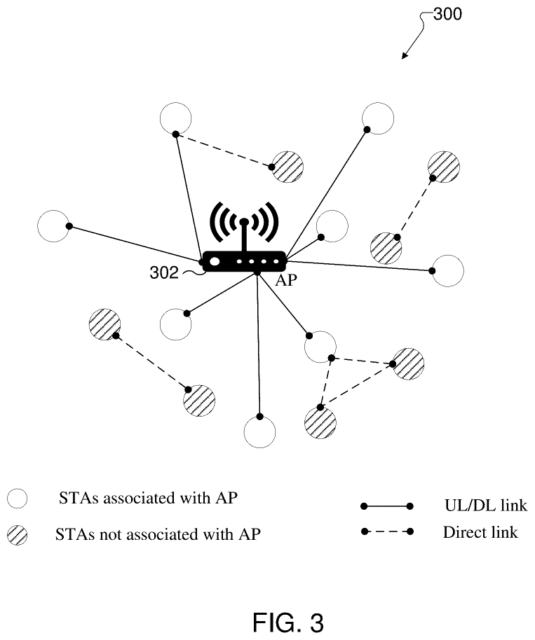

Better support for low-latency applications is desirable in next generation WLAN systems. It is not uncommon to observe numerous devices operating on the same wireless network. Many of such devices may be latency-tolerant but still contend with the devices with low-latency applications for the same time and frequency resources. In some cases, the AP as the network controller may not have enough control over the unregulated/unmanaged traffic that contends with the low-latency traffic within the infrastructure basic service set (BSS). Some of the unmanaged traffic that interferes with the AP's BSS's latency sensitive traffic may come from uplink (UL)/downlink (DL) or direct link communications within the infrastructure BSS that the AP manages. Other interference with the AP's BSS's latency sensitive traffic may be due to transmission in a neighboring infrastructure (overlapping) BSS (OBSS). Yet other interference with the AP's BSS's latency sensitive traffic may come from a neighboring independent BSS or P2P network as shown in FIG. 3.

FIG. 3 illustrates an example wireless network 300 where infrastructure traffic and non-infrastructure traffic coexist according to embodiments of the present disclosure. The embodiment of a wireless network of FIG. 3 is for illustration only. Different embodiments of a wireless network where infrastructure traffic and non-infrastructure traffic coexist could be used without departing from the scope of this disclosure.

In the example of FIG. 3, an AP 302 is associated with several STAs. The traffic between the AP and associated STAs is infrastructure traffic with respect to the network of AP 302. FIG. 3 also shows several STAs not associated with AP 302. Traffic generated by or transmitted to the STAs not associated with AP 302 is non-infrastructure traffic with respect to the network of AP 302.

Although FIG. 3 illustrates an example wireless network 300 where infrastructure traffic and non-infrastructure traffic coexist, various changes may be made to FIG. 3. For example, FIG. 3 could include additional APS, fewer or more STAs, etc. according to particular needs.

Mechanisms for next generation WLAN systems to better handle unmanaged traffic in order to prioritize the low-latency (LL) traffic in the network is desirable. Current WLAN standards are unclear regarding how a transmission opportunity (TXOP) can be redistributed within a peer-to-peer (P2P) group. Such a procedure is desirable for efficient P2P group operation. Various embodiments of the present disclosure provide mechanisms for allocating a TXOP within a P2P group.

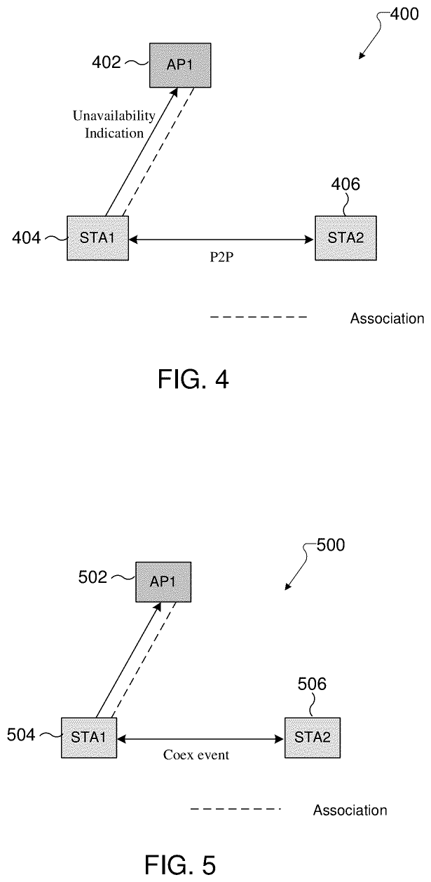

According to existing WLAN standards, a first STA can indicate to its associated AP a sequence of time periods during which the first STA will be unavailable for frame exchanges with the AP. During the unavailability with the AP, the first STA may be involved in P2P communication with a second STA as shown in FIG. 4. Alternatively, the first STA may also be unavailable due to a scheduled coexistence (coex) event, for example, with STA2 as shown in FIG. 5.

FIG. 4 illustrates an example 400 of an unavailability indication of a first STA to an AP due to a scheduled P2P communication with a second STA according to embodiments of the present disclosure. The embodiment of an unavailability indication of FIG. 4 is for illustration only. Different embodiments of an unavailability indication of a first STA to an AP due to a scheduled P2P communication with a second STA could be used without departing from the scope of this disclosure.

In the example of FIG. 4, AP 402 (AP1) is associated with STA 404 (STA1), and STA 404 is involved in a scheduled P2P communication with STA 406 (STA2). STA 404 is transmitting an unavailability indication to AP 402 because of the scheduled P2P communication with STA 406.

Although FIG. 4 illustrates an example 400 of an unavailability indication of a first STA to an AP due to a scheduled P2P communication with a second STA, various changes may be made to FIG. 4. For example, STA 404 could be involved with P2P communications with other STAs, etc. according to particular needs.

FIG. 5 illustrates an example 500 of an unavailability indication of a first STA to an AP due to a scheduled coex event with a second STA according to embodiments of the present disclosure. The embodiment of an unavailability indication of FIG. 5 is for illustration only. Different embodiments of an unavailability indication of a first STA to an AP due to a scheduled coex event with a second STA could be used without departing from the scope of this disclosure.

In the example of FIG. 5, AP 502 (AP1) is associated with STA 504 (STA1), and STA 504 is involved in a scheduled coex event with STA 506 (STA2). STA 504 is transmitting an unavailability indication to AP 502 because of the scheduled coex event with STA 506.

Although FIG. 5 illustrates an example 500 of an unavailability indication of a first STA to an AP due to a scheduled coex event with a second STA, various changes may be made to FIG. 5. For example, STA 504 could be involved with coex events with other STAs, etc. according to particular needs.

For the scenario where a non-AP STA intends to establish a P2P TWT schedule with its associated AP in order to indicate the non-AP STA's unavailability schedule, if the non-AP STA negotiates with the AP to set up the P2P TWT schedule with the AP, then during the P2P TWT negotiation, the non-AP STA can indicate to the AP a mode of P2P TWT operation where the non-AP STA can receive high-priority traffic from the AP during a P2P TWT SP corresponding to the P2P TWT schedule. In some embodiments, such a mode can be referred to as a quality of service (QOS)-aware unavailability indication mode.

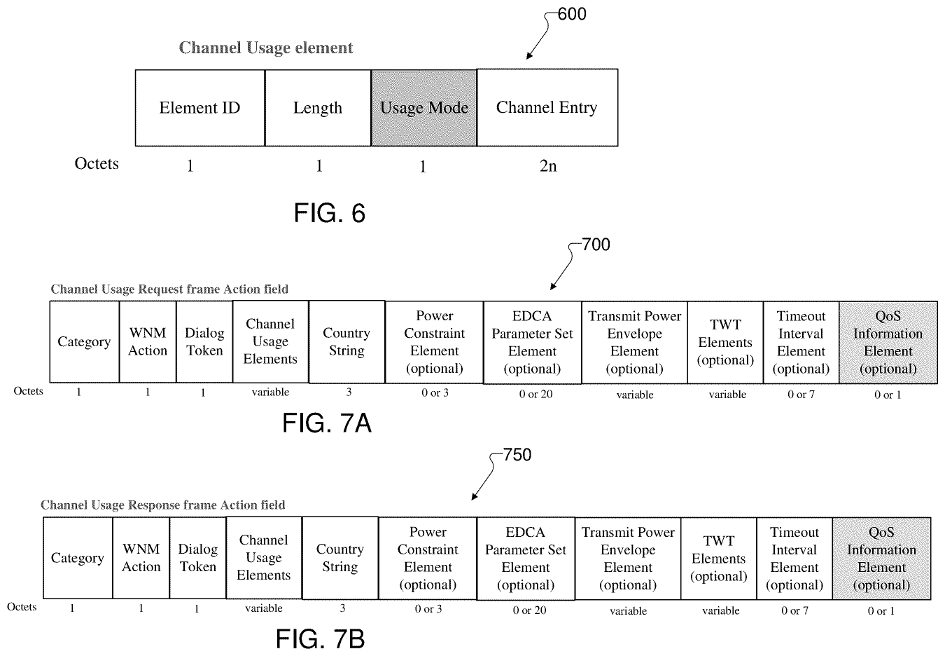

For the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode is a QoS-aware unavailability mode, then during the P2P TWT negotiation, the non-AP STA can indicate the mode in the usage mode field of the channel usage element included in the channel rsage request frame sent by the non-AP STA. An example of a possible format of the channel usage element, including the QoS-aware unavailability indication option, is shown in FIG. 6.

FIG. 6 illustrates an example format 600 of a QoS-aware unavailability indication option as a mode of P2P TWT unavailability according to embodiments of the present disclosure. The embodiment of a QoS-aware unavailability indication option of FIG. 6 is for illustration only. Different embodiments of a QoS-aware unavailability indication option as a mode of P2P TWT unavailability could be used without departing from the scope of this disclosure.

In the example of FIG. 6, format 600 is a channel usage element that includes a usage mode field. The usage mode may be identified by including one of the values shown in table 1 in the usage mode field. When the value is 7, the usage mode is a QoS aware-unavailability indication.

TABLE 1
Usage Mode Definitions

| Value | Usage Mode |
|---|---|
| 0 | Channel-usage-aidable BSS |
| 1 | Off-channel TDLS direct link |
| 2 | Channel-usage-aidable BSS in which none of the |
| | channel-usage-aiding BSSs that belong to the same |
| | ESS operate on the channels identified by |
| | the Channel Entry field |
| 3 | Complete Unavailability indication |
| 4 | Channel-usage-aidable BSS channel switch request |
| 5 | Capability notification |
| 6 | Probabilistic Unavailability indication |
| 7 | QoS-aware Unavailability indication |
| 8-254 | Reserved |
| 255 | Unknown request |

Although FIG. 6 illustrates an example format 600 of a QoS-aware unavailability indication option as a mode of P2P TWT unavailability, various changes may be made to FIG. 6. For example, various changes to fields could be made, etc. according to particular needs.

For the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, the non-AP STA can include a QoS information element (IE) field in the channel usage request frame sent to the AP used for the P2P TWT negotiation. The QoS information element may contain information pertaining to the QoS-related criteria for the availability of the STA during a P2P TWT SP corresponding to the P2P TWT schedule. An example of a possible format of a channel usage request frame including a QoS Information Element field is shown in FIG. 7A.

FIG. 7A illustrates an example format 700 of a channel usage request frame including a QoS information element according to embodiments of the present disclosure. The embodiment of a channel usage request frame including a QoS information element of FIG. 7A is for illustration only. Different embodiments of a channel usage request frame including a QoS information element could be used without departing from the scope of this disclosure.

In the example of FIG. 7A, format 700 is a channel usage request frame that includes an optional QoS information element field. The QoS information element field, if included, may contain one or more QoS information elements.

Although FIG. 7A illustrates an example format 700 of a channel usage request frame including a QoS information element, various changes may be made to FIG. 7A. For example, various changes to fields could be made, etc. according to particular needs.

Upon receiving a channel usage request frame from a non-AP STA that includes one or more QoS information elements, the AP may send a channel usage response frame to the non-AP STA, where the channel usage response frame may include one or more QoS information elements. An example of a possible format of the channel usage response frame is shown in FIG. 7B.

FIG. 7B illustrates an example format 750 of a channel usage response frame including a QoS information element according to embodiments of the present disclosure. The embodiment of a channel usage response frame including a QoS information element of FIG. 7B is for illustration only. Different embodiments of a channel usage response frame including a QoS information element could be used without departing from the scope of this disclosure.

In the example of FIG. 7B, format 750 is a channel usage response frame that includes an optional QoS information element field. The QoS information element field, if included, may contain one or more QoS information elements.

Although FIG. 7B illustrates an example format 750 of a channel usage response frame including a QoS information element, various changes may be made to FIG. 7B. For example, various changes to fields could be made, etc. according to particular needs.

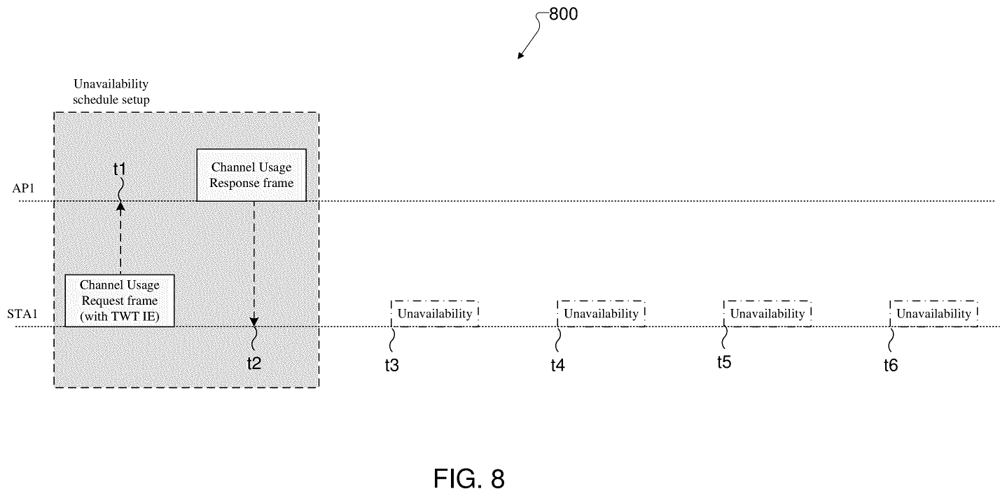

For the scenario where a first STA has set up an unavailability schedule or P2P target wake time (TWT) schedule with its associated AP, existing baseline WLAN specifications do not provide a mechanism for the first STA to change the parameters of the unavailability service period (SP) or P2P TWT SPs as shown in FIG. 8.

FIG. 8 illustrates an example 800 of an unavailability schedule or P2P TWT SPs according to embodiments of the present disclosure. The embodiment of an unavailability schedule or P2P TWT SPs of FIG. 8 is for illustration only. Different embodiments of an unavailability schedule or P2P TWT SPs could be used without departing from the scope of this disclosure.

In the example of FIG. 8, AP1 and STA1 perform an unavailability schedule setup where at time “t1” STA1 transmits a channel usage request frame with a TWT information element (IE) to AP1, and STA1 receives a channel usage response frame from AP1 at time “t2” After the unavailability schedule setup, STA1 is unavailable to AP1 for a number of fixed time periods beginning at times “t3”, “t4”, “t5”, and “t6”. These periods may correspond with an unavailability schedule or P2P TWT SPs.

Although FIG. 8 illustrates an example 800 of an unavailability schedule or P2P TWT SPs, various changes may be made to FIG. 8. For example, various changes to unavailability times could be made, etc. according to particular needs.

During unavailability service periods such as shown in FIG. 8, an AP may have urgent traffic for a STA. However, the STA would not be able to receive that urgent traffic during the unavailability SP. This may disrupt the STA's latency-sensitive applications. A non-AP STA may want to prioritize traffic based on the access category. For example, for Access Category Voice (AC_VO), the STA may want to prioritize DL traffic over unavailability due to coex constraints. However, existing WLAN specifications do not provide such a mechanism.

Various embodiments of the present disclosure provide mechanisms and frameworks to prioritize frame exchanges with an AP during an unavailability window defined by a P2P schedule where the prioritization is based on the access category of the frame.

As previously noted, during unavailability service periods such as shown in FIG. 6, an AP may have urgent traffic for a STA. However, the STA would not be able to receive that urgent traffic during the unavailability SP. This may disrupt the STA's latency-sensitive applications for restricted TWT (R-TWT) operation.

Various embodiments of the present disclosure provide mechanisms and frameworks to prioritize R-TWT SPs for P2P TWT communication for unavailability indication.

As noted above, various embodiments of the present disclosure provide mechanisms for allocating a TXOP within a P2P group.

In some embodiments, a first AP can allocate a portion of its own TXOP to a group of STAs, where more than one of the STAs may form a P2P group. In other words, the AP can allocate a portion of its own TXOP to a P2P group, where the P2P group can comprise one or more P2P STAs.

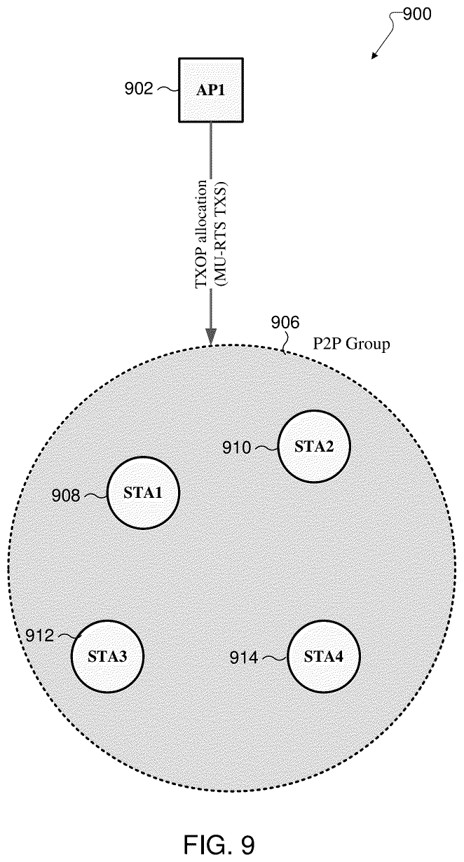

In some embodiments, for the scenario where an AP intends to allocate a portion of its own TXOP to a P2P group, the AP can send a multi-user request to send (MU-RTS) TXOP sharing (TXS) trigger frame to the P2P group and indicate in the user info field the identifier of the P2P group to indicate that the recipient of the trigger frame is the P2P group. For example, the AP can include a neighbor awareness networking (NAN) cluster ID or P2P group ID as an identifier of the P2P group in the trigger frame, similar as shown in FIG. 9.

FIG. 9 illustrates an example 900 of a TXOP allocation to a P2P group according to embodiments of the present disclosure. The embodiment of a TXOP allocation to a P2P group of FIG. 9 is for illustration only. Different embodiments of a TXOP allocation to a P2P group could be used without departing from the scope of this disclosure.

In the example of FIG. 9, an AP 902 (AP1) transmits a TXOP allocation via an MU-RTS TXS trigger frame to a P2P group 906. The P2P group 906 includes the STAs 908 (STA1), 910 (STA2), 912 (STA3), and 914 (STA4).

Although FIG. 9 illustrates an example 900 of a TXOP allocation to a P2P group, various changes may be made to FIG. 9. For example, the P2P group could include fewer or more STAs, etc. according to particular needs.

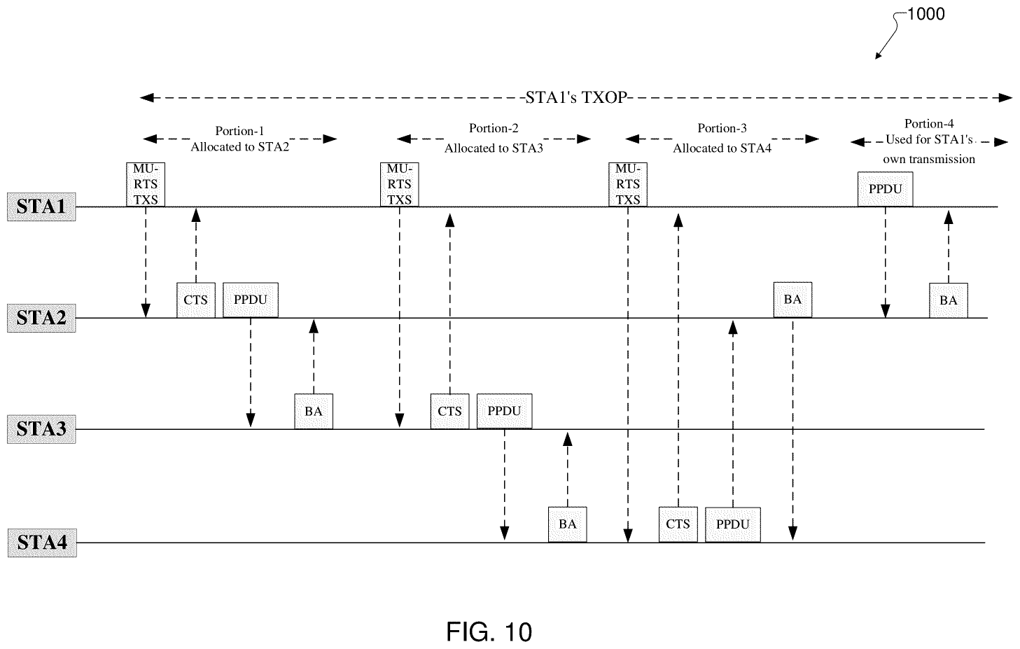

In some embodiments, a first STA that is a member of a P2P group can assume the role of a P2P group leader or P2P TXOP distribution leader. A P2P group leader can be responsible for allocating a TXOP to one or more other STAs within the P2P group. For example, if the first STA is the owner of a TXOP, then the first STA can allocate a first portion of the TXOP to a second STA, a second portion of the TXOP to a third STA, and so on. The first STA can use a third portion of that TXOP for its own transmission. This is shown in FIG. 10.

FIG. 10 illustrates an example 1000 of a TXOP distribution by a P2P group leader according to embodiments of the present disclosure. The embodiment of a TXOP distribution by a P2P group leader of FIG. 10 is for illustration only. Different embodiments of a TXOP distribution by a P2P group leader could be used without departing from the scope of this disclosure.

In the example of FIG. 10, STA1, STA2, STA3, and STA4 form a P2P group (for example, a NAN cluster). STA1 is the P2P group leader. STA1 is the owner of a TXOP. STA1 allocates a first portion of that TXOP to STA2, a second portion to STA3, and a third portion to STA4. STA1 uses the fourth portion of the TXOP for STA1's own transmission to STA2. Upon receiving the respective portions of the TXOP, STA2 transmits to STA3, STA3 transmits to STA4, and STA4 transmits to STA2. In the example of FIG. 10, STA1 uses an MU-RTS TXS (e.g., a Mode-2 version) trigger frame for allocating the TXOP to the other P2P STAs. Other trigger frames can also be used.

Although FIG. 10 illustrates an example 1000 of a TXOP distribution by a P2P group leader, various changes may be made to FIG. 10. For example, the P2P group could include fewer or more STAs, etc. according to particular needs.

In some embodiments, for the scenario where an AP allocates a portion of its own TXOP to a P2P group and sends a trigger frame (e.g., an MU-RTS TXS trigger frame [for example, a Mode-2 version of this trigger frame or a new mode of this trigger frame that would indicate that the TXOP allocation through this trigger frame is for a P2P group]) to indicate the allocation of the TXOP for the P2P group, a first STA that is a member of the P2P group can assume the role of ‘P2P Group Leader’ or ‘P2P TXOP Distribution Leader’ for that group. Alternatively, in some other embodiments, the first STA can assume the role of the P2P group leader or P2P TXOP distribution leader before the AP allocates the TXOP to the P2P group. In embodiments such as these, upon receiving the TXOP from the AP, the first STA that is a P2P group leader can further allocate different portions of that TXOP to different other STAs within the P2P group or use another portion of the TXOP for the first STA's own transmission.

In some embodiments, for TXOP allocation, the AP can indicate in the trigger frame that the TXOP allocated through this trigger frame is for a P2P group with P2P group ID=X. For example, the user info field can contain the P2P group ID. In some embodiments, the trigger frame can be broadcast in nature. Alternatively, in some other embodiments, the TXOP can be multicast. Alternatively, in some other embodiments, the TXOP can be individually addressed where the recipient of the trigger frame can be the P2P group leader of the P2P group.

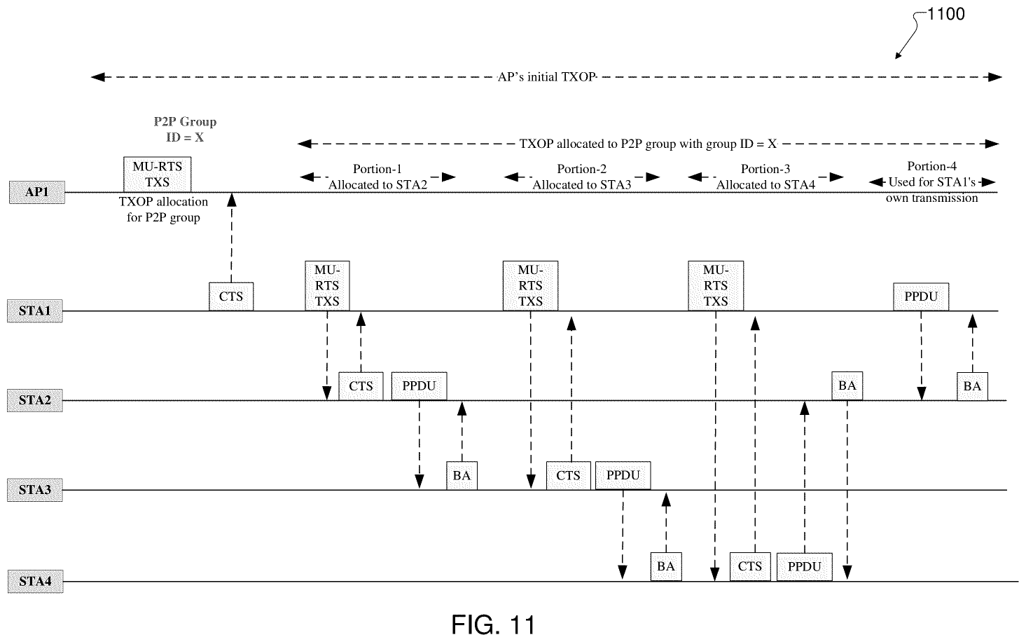

FIG. 11 illustrates an example 1100 of a redistribution of a TXOP received from an AP according to embodiments of the present disclosure. The embodiment of a redistribution of a TXOP received from an AP of FIG. 11 is for illustration only. Different embodiments of a redistribution of a TXOP received from an AP could be used without departing from the scope of this disclosure.

In the example of FIG. 11, AP1 is the initial TXOP owner. AP1 intends to allocate a portion of the TXOP to the P2P group with P2P group ID=X. AP1 sends an MU-RTS TXS (for example, a mode-2 version) trigger frame to make the allocation. STA1 is the P2P group leader of the P2P group with P2P group ID=X. Upon receiving the trigger frame STA1 re-allocates different portions of the TXOP to different STAs within the P2P group and uses one portion for its own transmission.

Although FIG. 11 illustrates an example 1100 of a redistribution of a TXOP received from an AP, various changes may be made to FIG. 11. For example, the P2P group could include fewer or more STAs, etc. according to particular needs.

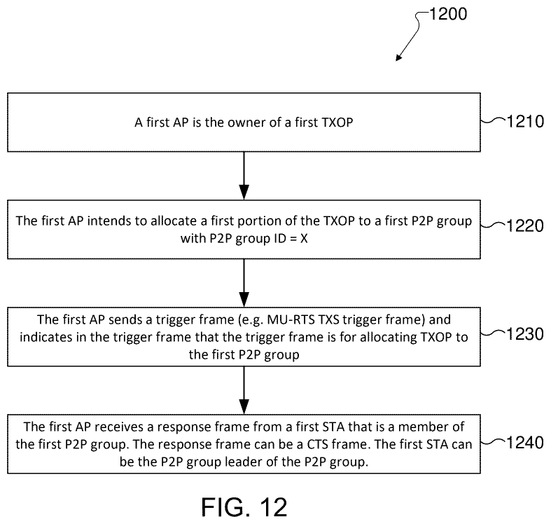

FIG. 12 illustrates an example AP side procedure 1200 for redistribution of a TXOP according to embodiments of the present disclosure. An embodiment of the procedure illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of an AP side procedure for redistribution of a TXOP could be used without departing from the scope of this disclosure.

In the example of FIG. 12, procedure 1200 begins at step 1210. At step 1210, a first AP (such as AP1 of FIG. 11) is the owner of a first TXOP.

At step 1220, the first AP intends to allocate a first portion of the first TXOP to a first P2P group with a P2P group ID=X (such as the P2P group including STA1, STA2, STA3, and STA4 of FIG. 11).

At step 1230, the first AP send a trigger frame (e.g., an MU-RTS TXS trigger frame) and indicates in the trigger frame that the trigger frame is for allocating the first TXOP to the first P2P group.

At step 1240, the first AP receives a response from a first STA that is a member of the first P2P group (such as STA1 of FIG. 11). For example, in some embodiments, the response frame can be a clear to send (CTS) frame. The first STA can be the P2P group leader of the P2P group.

Although FIG. 12 illustrates one example AP side procedure 1200 for redistribution of a TXOP, various changes may be made to FIG. 12. For example, while shown as a series of steps, various steps in FIG. 12 could overlap, occur in parallel, occur in a different order, occur any number of times, be omitted, or replaced by other steps.

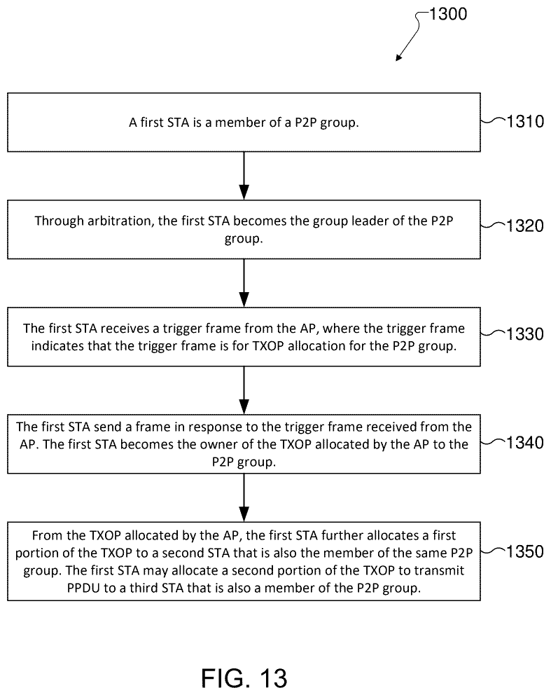

FIG. 13 illustrates an example P2P group leader side procedure 1300 for redistribution of a TXOP according to embodiments of the present disclosure. An embodiment of the procedure illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a P2P group leader side procedure for redistribution of a TXOP could be used without departing from the scope of this disclosure.

In the example of FIG. 13, procedure 1300 begins at step 1310. At step 1310, a first STA (such as STA1 of FIG. 11) is a member of a P2P group (such as the P2P group including STA1, STA2, STA3, and STA4 of FIG. 11).

At step 1320, through arbitration, the first STA becomes the group leader of the P2P group.

At step 1330, the first receiver receives a trigger frame from an AP (such as AP1 of FIG. 11). The trigger frame indicates that the trigger frame is for TXOP allocation for the P2P group.

At step 1340, the first STA sends a frame in response to the trigger frame received from the first AP. The first STA becomes the owner of the TXOP allocated by the AP to the P2P group.

At step 1350, from the TXOP allocated by the AP, the first STA allocates a first portion of the TXOP to a second STA that is also a member of the same P2P group. The first STA may allocate a second portion of the TXOP to transmit a PPDU to a third STA that is also a member of the P2P group.

Although FIG. 13 illustrates one example P2P group leader side procedure 1300 for redistribution of a TXOP, various changes may be made to FIG. 13. For example, while shown as a series of steps, various steps in FIG. 13 could overlap, occur in parallel, occur in a different order, occur any number of times, be omitted, or replaced by other steps.

As noted above, various embodiments of the present disclosure provide mechanisms and frameworks to prioritize frame exchanges with an AP during an unavailability window defined by a P2P schedule where the prioritization is based on the access category of the frame.

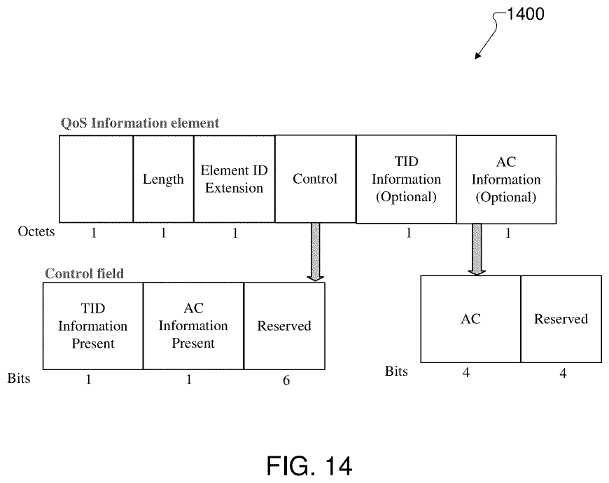

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, if the non-AP STA includes a QoS information elements field in the channel usage request frame sent to the AP used for the P2P TWT negotiation, then the QoS information element included in the QoS information elements field may include access category (AC) information. In some embodiments, if AC information is included in the QoS information elements field, then this may indicate to the AP that the STA may be awake and available during a P2P TWT SP corresponding to the P2P TWT schedule for a downlink frame transmission where the frame belongs to an AC indicated in the element. An example of a possible format of a QoS information element that contains a single AC value is shown in FIG. 14.

FIG. 14 illustrates an example format 1400 of a QoS information element that includes an AC value according to embodiments of the present disclosure. The embodiment of a QoS information element that includes an AC value of FIG. 14 is for illustration only. Different embodiments of a QoS information element that includes an AC value could be used without departing from the scope of this disclosure.

In the example of FIG. 14, format 1400 is a QoS information element. For format 1400, whether AC Information is present or not in the QoS information element is indicated by the AC Information Present field in the Control field. If AC Information Present is set to 1, then it may indicate that the AC Information field is present in the QoS information element. Otherwise, the AC information field is not present. The AC field in the AC Information field indicates an AC value.

Although FIG. 14 illustrates an example format 1400 of a QoS information element that includes an AC value, various changes may be made to FIG. 14. For example, various changes to fields could be made, etc. according to particular needs.

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, if the non-AP STA includes an AC value in a QoS information element included in the channel usage request frame sent to the AP used for the P2P TWT negotiation, then the channel usage request frame may indicate that the non-AP STA may be available for receiving a frame corresponding to the indicated AC even if the frame reception overlaps with a P2P TWT SP corresponding to the P2P TWT schedule. In some other embodiments, the inclusion of the AC may indicate that the non-AP STA may be available for receiving the frame if the frame corresponds to any AC, the value of which is greater than the value indicated in the QoS information element.

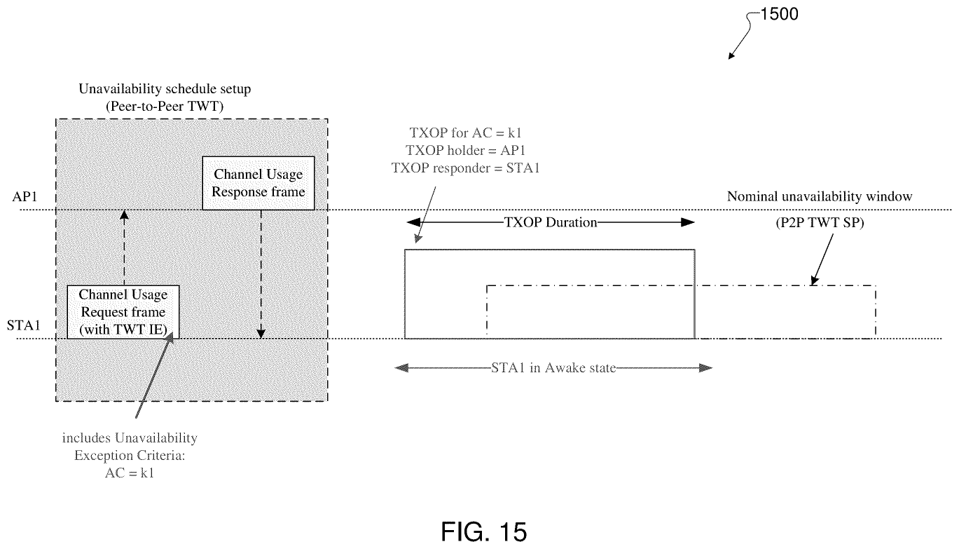

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, if the non-AP STA includes an AC value in a QoS information element included in the channel usage request frame sent to the AP used for the P2P TWT negotiation, then the channel usage request frame may indicate that the non-AP STA as a TXOP responder may be available (e.g., in an awake state) for receiving a frame corresponding to the indicated AC even if the frame reception overlaps with a P2P TWT SP corresponding to the P2P TWT schedule if the frame corresponds to an AC value indicated in the QoS information element included in the channel usage request frame, as shown in FIG. 15.

FIG. 15 illustrates an example 1500 of STA availability during a P2P TWT SP due to the reception of a frame for an indicated AC according to embodiments of the present disclosure. The embodiment of STA availability during a P2P TWT SP due to the reception of a frame for an indicated AC of FIG. 15 is for illustration only. Different embodiments of STA availability during a P2P TWT SP due to the reception of a frame for an indicated AC could be used without departing from the scope of this disclosure.

In the example of FIG. 15, AP1 and STA1 perform an unavailability schedule setup for P2P TWT, where STA1 transmits a channel usage request frame with an AC value in a QoS information element to AP1, and STA1 receives a channel usage response frame from AP1. The channel usage request frame may indicate that STA1 as a TXOP responder may be available for receiving a frame corresponding to the indicated AC even if the frame reception overlaps with a P2P TWT SP corresponding to the P2P TWT schedule if the frame corresponds to an AC value indicated in the QoS information element.

Although FIG. 15 illustrates an example 1500 of STA availability during a P2P TWT SP due to the reception of a frame for an indicated AC, various changes may be made to FIG. 15. For example, various changes to unavailability times could be made, etc. according to particular needs.

In some embodiments, if the non-AP STA includes an AC value in a QoS information element included in the channel usage request frame sent to the AP used for the P2P TWT negotiation, then the channel usage request frame may indicate that the non-AP STA as a TXOP responder may not be available for receiving a frame that does not correspond to the AC indicated in the QoS information element if the frame reception overlaps with a P2P TWT SP corresponding to the P2P TWT schedule. In such cases, the AP as the TXOP holder may end the TXOP before the unavailability SP starts for the non-AP STA.

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, if the non-AP STA includes an AC value in a QoS information element included in the channel usage request frame sent to the AP used for the P2P TWT negotiation, then it may indicate that the non-AP STA as a TXOP responder may be available (e.g., in awake state) for receiving a frame corresponding to the indicated AC even if the frame reception overlaps with a P2P TWT SP corresponding to the P2P TWT schedule if the frame corresponds to an AC value which is higher than the value indicated in the AC subfield indicated in the QoS information element included in the channel usage request frame.

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, if the non-AP STA includes an AC value in a QoS information element included in the channel usage request frame sent to the AP used for the P2P TWT negotiation, then the channel usage request frame may indicate that the non-AP STA as a TXOP responder may be available (e.g., in awake state) for receiving a frame corresponding to the indicated AC even if the frame reception overlaps with a P2P TWT SP corresponding to the P2P TWT schedule if the frame corresponds to an AC value which is lower than the value indicated in the AC subfield indicated in the QoS information element included in the channel usage request frame.

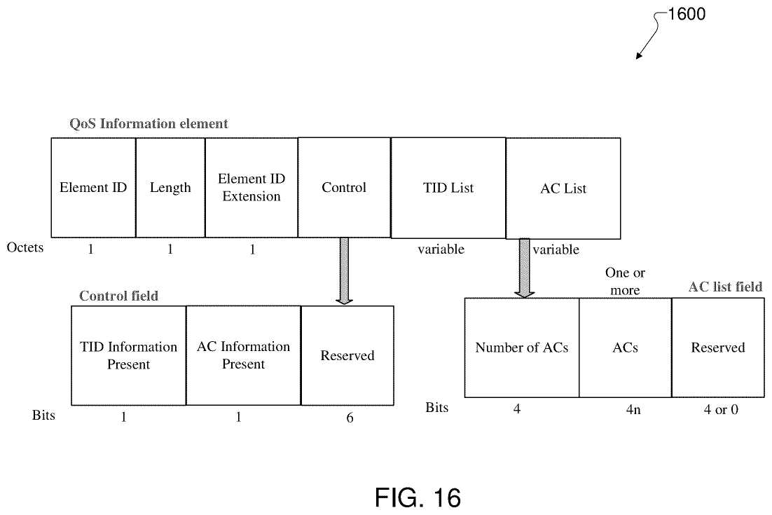

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, then the non-AP STA may indicate multiple ACs in a QoS information element included in the channel usage request frame sent to the AP used for the P2P TWT negotiation. An example of a possible format of for a QoS information element with multiple ACs is shown in FIG. 16.

FIG. 16 illustrates example format 1600 of a QoS information element that includes a list of AC values according to embodiments of the present disclosure. The embodiment of a QoS information element that includes a list of AC values of FIG. 16 is for illustration only. Different embodiments of a QoS information element that includes a list of AC values could be used without departing from the scope of this disclosure.

In the example of FIG. 16, format 1600 is a QoS information element. For format 1600, the AC list subfield may include one or more AC information. The ACs subfield may include one or more AC values. The Number of ACs field may indicate the number of AC values included in the AC List subfield.

Although FIG. 16 illustrates an example format 1600 of a QoS information element that includes a list AC values, various changes may be made to FIG. 16. For example, various changes to fields could be made, etc. according to particular needs.

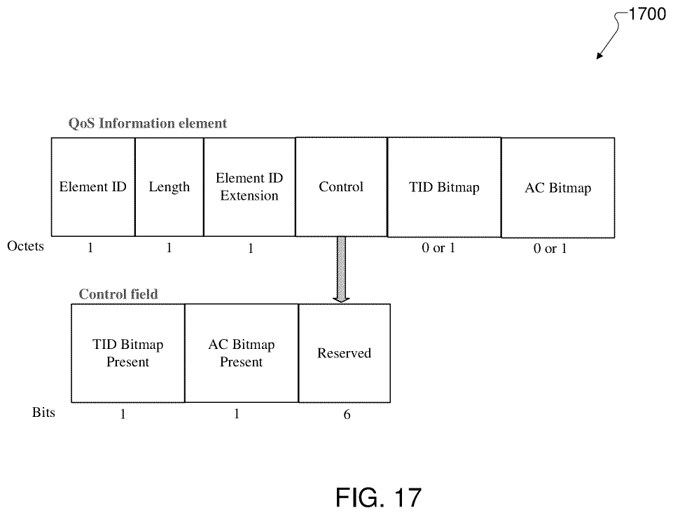

In some other embodiments, instead of including the values of the AC, an AC bitmap field can also be included in a QoS information element. An example of a possible format of a QoS information element, including an AC Bitmap, is shown in FIG. 17. FIG. 17 also shows a traffic identifier (TID) bitmap. The usage of the TID bitmap can be similar to the usage of the AC bitmap.

FIG. 17 illustrates example format 1700 of a QoS information element that includes an AC bitmap according to embodiments of the present disclosure. The embodiment of a QoS information element that includes an AC bitmap of FIG. 17 is for illustration only. Different embodiments of a QoS information element that includes an AC bitmap could be used without departing from the scope of this disclosure.

In the example of FIG. 17, format 1700 is a QoS information element. For format 1700, the AC Bitmap Present subfield indicates whether or not an AC Bitmap subfield is present in the QoS information element. If the AC Bitmap Subfield is set to 1, it may indicate that an AC Bitmap subfield is present in the QoS information element. Otherwise, an AC bitmap subfield is not present.

The AC Bitmap field indicates a bitmap for indicating different AC values. If a bit in the AC Bitmap field is set to 1, it may indicate that the P2P TWT schedule is set up with prioritization for the AC corresponding to that bit position. Otherwise, the AC is not in the prioritization list for that P2P TWT schedule negotiation.

Although FIG. 17 illustrates an example format 1700 of a QoS information element that includes an AC bitmap, various changes may be made to FIG. 17. For example, various changes to fields could be made, etc. according to particular needs.

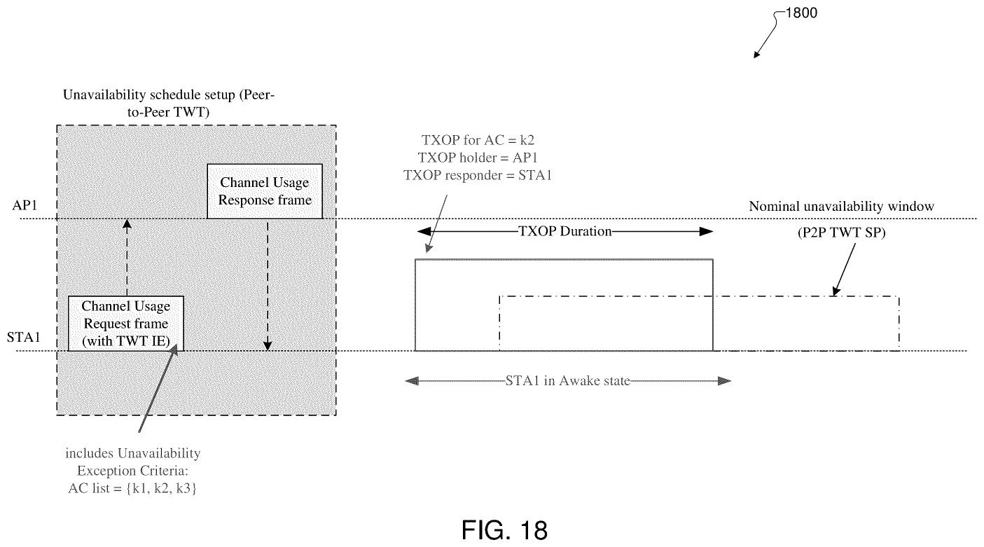

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, if the non-AP STA includes one or more AC values (a list of ACs) in a QoS information element included in the channel usage request frame sent to the AP used for the P2P TWT negotiation, then the channel usage request frame may indicate that the non-AP STA as a TXOP responder may be available (e.g., in awake state) for receiving a frame corresponding to an AC that is indicated in the list of ACs even if the frame reception overlaps with a P2P TWT SP corresponding to the P2P TWT schedule if the frame corresponds to an AC value indicated in the QoS information element included in the channel usage request frame, such as shown in FIG. 18.

FIG. 18 illustrates an example 1800 of STA availability for receiving a frame corresponding to an AC listed in a QoS information element according to embodiments of the present disclosure. The embodiment of STA availability for receiving a frame corresponding to an AC listed in a QoS information element of FIG. 18 is for illustration only. Different embodiments of STA availability for receiving a frame corresponding to an AC listed in a QoS information element could be used without departing from the scope of this disclosure.

In the example of FIG. 18, AP1 and STA1 perform an unavailability schedule setup for P2P TWT, where STA1 transmits a channel usage request frame with one or more AC values (a list of ACs) in a QoS information element to AP1, and STA1 receives a channel usage response frame from AP1. The channel usage request frame may indicate that STA1 as a TXOP responder may be available for receiving a frame corresponding to an AC that is indicated in the list of ACs even if the frame reception overlaps with a P2P TWT SP corresponding to the P2P TWT schedule if the frame corresponds to an AC value indicated in the QoS information element.

Although FIG. 18 illustrates an example 1800 of STA availability for receiving a frame corresponding to an AC listed in a QoS information element, various changes may be made to FIG. 18. For example, various changes to unavailability times could be made, etc. according to particular needs.

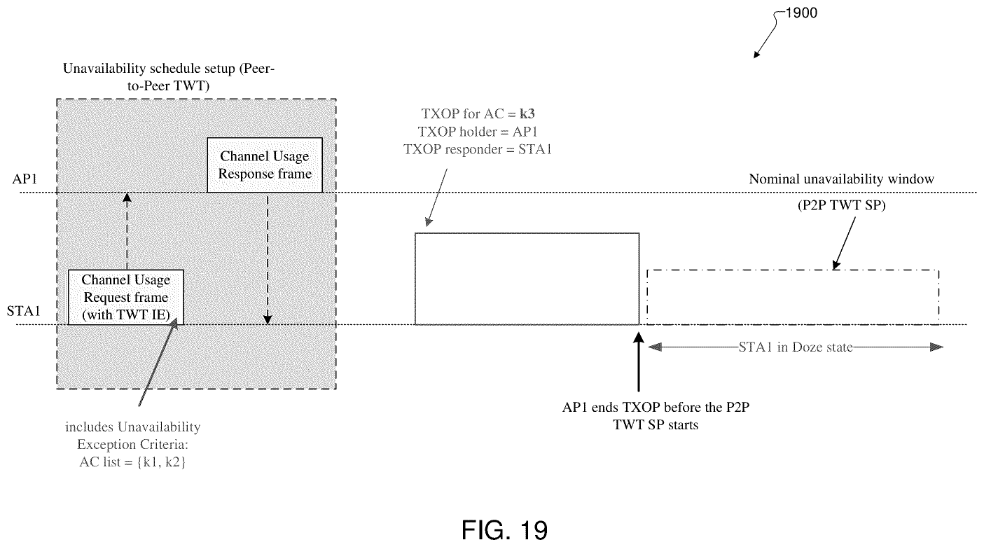

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, if the non-AP STA includes one or more AC values (a list of ACs) in a QoS information element included in the channel usage request frame sent to the AP used for the P2P TWT negotiation, then it may indicate that the non-AP STA as a TXOP responder may not be available (e.g., may be in doze state) for receiving a frame corresponding to a AC that is not included in the AC List if the frame reception overlaps with a P2P TWT SP corresponding to the P2P TWT schedule, as shown in FIG. 19.

FIG. 19 illustrates another example 1900 of STA availability for receiving a frame corresponding to an AC listed in a QoS information element according to embodiments of the present disclosure. The embodiment of STA availability for receiving a frame corresponding to an AC listed in a QoS information element of FIG. 19 is for illustration only. Different embodiments of STA availability for receiving a frame corresponding to an AC listed in a QoS information element could be used without departing from the scope of this disclosure.

In the example of FIG. 19, AP1 and STA1 perform an unavailability schedule setup for P2P TWT, where STA1 transmits a channel usage request frame with an one or more AC values (a list of ACs) in a QoS information element to AP1, and STA1 receives a channel usage response frame from AP1. The channel usage request frame may indicate that STA1 as a TXOP responder may not be available for receiving a frame corresponding to an AC that is not included in the list of ACs if the frame reception overlaps with a P2P TWT SP corresponding to the P2P TWT schedule.

Although FIG. 19 illustrates an example 1900 of STA availability for receiving a frame corresponding to an AC listed in a QoS information element, various changes may be made to FIG. 19. For example, various changes to unavailability times could be made, etc. according to particular needs.

As noted above, various embodiments of the present disclosure provide mechanisms and frameworks to prioritize R-TWT SPs for P2P TWT communication for unavailability indication.

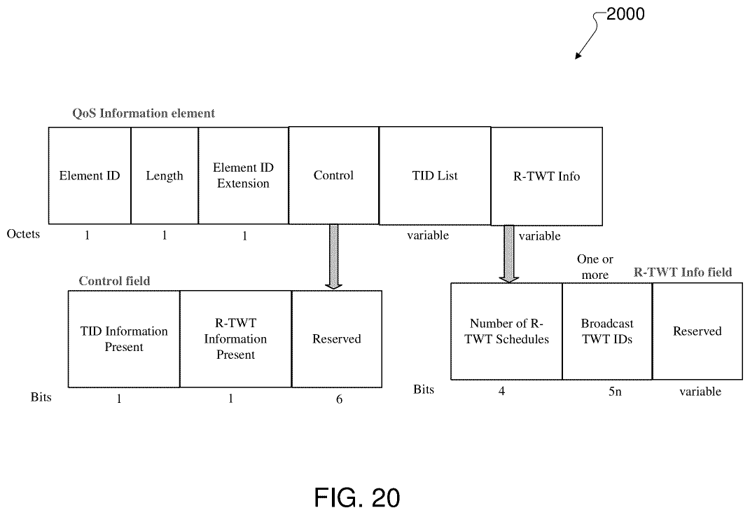

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, if the non-AP STA includes a QoS information elements field in the channel usage request frame sent to the AP used for the P2P TWT negotiation, then the QoS information element included in the QoS information elements field may include restricted TWT (R-TWT) schedule information. In some embodiments, if R-TWT information is included, then this may indicate to the AP that the STA may be awake and available during a P2P TWT SP corresponding to the P2P TWT schedule for a downlink or uplink frame transmission if the P2P TWT SP overlaps with the R-TWT SP. In some embodiments, the R-TWT SPs may correspond to R-TWT schedule in which the non-AP STA is a member. An example of a possible format of a QoS information element that contains a R-TWT Schedule information is shown in FIG. 20.

FIG. 20 illustrates an example format 2000 of a QoS information element that includes an AC value according to embodiments of the present disclosure. The embodiment of a QoS information element that includes an AC value of FIG. 20 is for illustration only. Different embodiments of a QoS information element that includes an AC value could be used without departing from the scope of this disclosure.

For format 2000, whether the R-TWT information is present or not in the QoS information element is indicated by the R-TWT Information Present field in the Control field. If the R-TWT Information Present is set to 1, then it may indicate that the R-TWT Info field is present in the QoS information element. Otherwise, the R-TWT Info field is not present.

The Number of R-TWT Schedules subfield indicates the number of R-TWT schedules whose information is carried in the R-TWT Info field. In some embodiments, the Number of R-TWT Schedules subfield may indicate the number of broadcast TWT IDs present in the Broadcast TWT IDs subfield in the R-TWT Info field.

The Broadcast TWT IDs subfield in the R-TWT Info field may indicate one or more broadcast TWT IDs corresponding to one or more broadcast TWT schedules indicated by the QoS information element.

Although FIG. 20 illustrates an example format 2000 of a QoS information element that includes an AC value, various changes may be made to FIG. 20. For example, various changes to fields could be made, etc. according to particular needs.

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, if non-AP STA includes a broadcast TWT ID corresponding to a restricted TWT schedule in a QoS information element included in the channel usage request frame sent to the AP used for the P2P TWT negotiation, then the channel usage request may indicate that the non-AP STA may be available for receiving a frame corresponding to a TID negotiated for the indicated R-TWT schedule even if the R-TWT SP overlaps with a P2P TWT SP corresponding to the P2P TWT schedule. In some other embodiments, the inclusion of the broadcast TWT ID corresponding to an R-TWT schedule may indicate that the non-AP STA may be available for receiving the frame during the R-TWT SP.

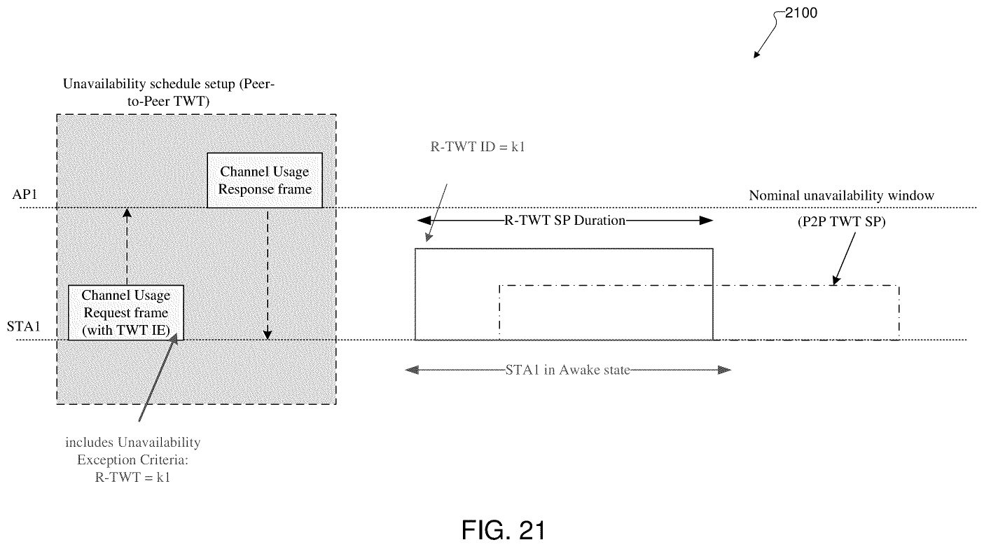

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, if the non-AP STA includes a broadcast TWT ID corresponding to an R-TWT schedule in a QoS information element included in the channel usage request frame sent to the AP used for the P2P TWT negotiation, then the channel usage request may indicate that the non-AP STA as a TXOP responder may be available (e.g., in awake state) for receiving a frame during the R-TWT SP even if the frame reception overlaps with a P2P TWT SP corresponding to the P2P TWT schedule, as shown in FIG. 21.

FIG. 21 illustrates an example 2100 of STA availability during a P2P TWT SP due to the reception of a frame for an indicated R-TWT schedule according to embodiments of the present disclosure. The embodiment of STA availability during a P2P TWT SP due to the reception of a frame for an indicated R-TWT schedule of FIG. 21 is for illustration only. Different embodiments of STA availability during a P2P TWT SP due to the reception of a frame for an indicated R-TWT schedule could be used without departing from the scope of this disclosure.

In the example of FIG. 21, AP1 and STA1 perform an unavailability schedule setup for P2P TWT, where STA1 transmits a channel usage request frame with a broadcast TWT ID corresponding to an R-TWT schedule in a QoS information element to AP1, and STA1 receives a channel usage response frame from AP1. The channel usage request frame may indicate that STA1 as a TXOP responder may be available for receiving a frame during the R-TWT SP even if the frame reception overlaps with a P2P TWT SP corresponding to the P2P TWT schedule if the frame corresponds to the PTP TWT schedule.

Although FIG. 21 illustrates an example 2100 of STA availability during a P2P TWT SP due to the reception of a frame for an indicated R-TWT schedule, various changes may be made to FIG. 21. For example, various changes to unavailability times could be made, etc. according to particular needs.

In some embodiments, if the non-AP STA includes an broadcast TWT ID corresponding to an R-TWT schedule value in a QoS information element included in the channel usage request frame sent to the AP used for the P2P TWT negotiation, then the channel usage request frame may indicate that the non-AP STA as a TXOP responder may not be available for receiving a frame during an R-TWT SP that does not correspond to the R-TWT schedule indicated in the QoS information element if the R-TWT SP overlaps with a P2P TWT SP corresponding to the P2P TWT schedule.

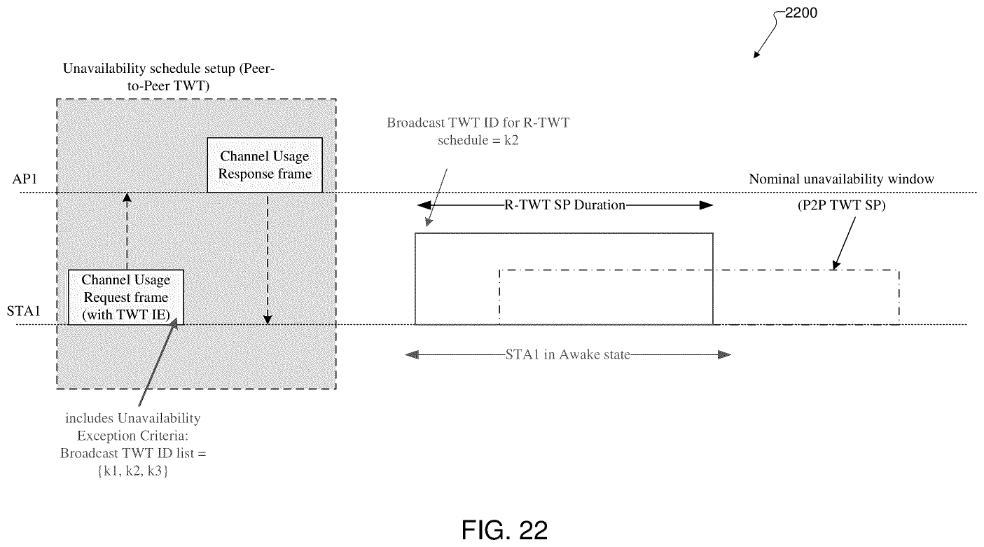

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, if the non-AP STA includes one or more R-TWT schedule information in a QoS information element included in the channel usage request frame sent to the AP used for the P2P TWT negotiation, then the channel usage request frame may indicate that the non-AP STA may be available (e.g., in awake state) for receiving or transmitting a frame corresponding during the corresponding R-TWT SPs of the R-TWT schedules that are indicated in the list of broadcast TWT IDs corresponding to the R-TWT schedules even if the R-TWT SPs overlap with a P2P TWT SP corresponding to the P2P TWT schedule, as shown in FIG. 22.

FIG. 22 illustrates an example 2200 of STA availability for receiving a frame corresponding to an R-TWT schedule listed in a QoS information element according to embodiments of the present disclosure. The embodiment of STA availability for receiving a frame corresponding to an R-TWT schedule listed in a QoS information element of FIG. 22 is for illustration only. Different embodiments of STA availability for receiving a frame corresponding to an R-TWT schedule listed in a QoS information element could be used without departing from the scope of this disclosure.

In the example of FIG. 22, AP1 and STA1 perform an unavailability schedule setup for P2P TWT, where STA1 transmits a channel usage request frame with one or more R-TWT schedules information in a QoS information element to AP1, and STA1 receives a channel usage response frame from AP1. The channel usage request frame may indicate that STA1 may be available for receiving or transmitting a frame during the corresponding R-TWT SPs of the RT-TWT schedules that are indicated in the list of broadcast TWT IDs corresponding to the R-TWT schedules even if the frame reception overlaps with a P2P TWT SP corresponding to the P2P TWT schedule.

Although FIG. 22 illustrates an example 2200 of STA availability for receiving a frame corresponding to an R-TWT schedule listed in a QoS information element, various changes may be made to FIG. 22. For example, various changes to unavailability times could be made, etc. according to particular needs.

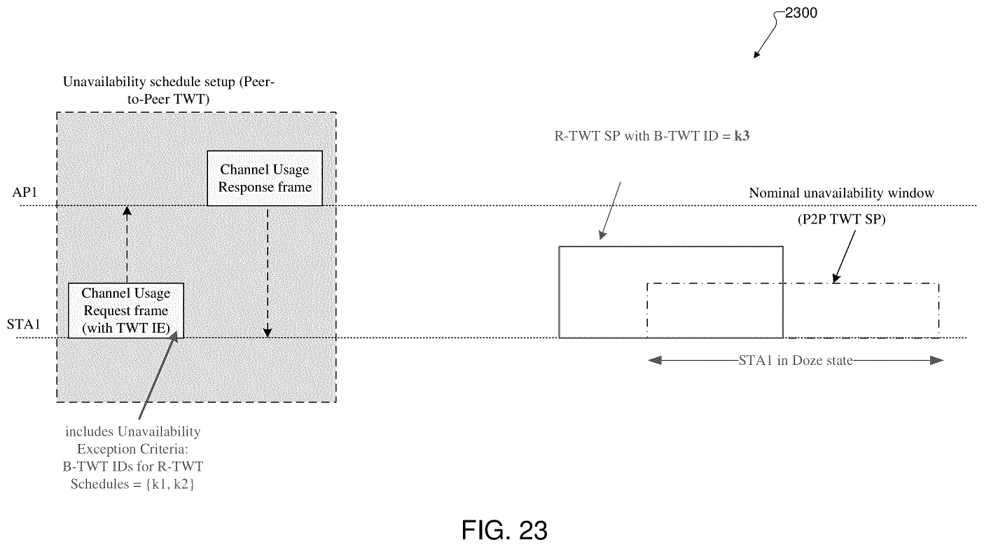

In some embodiments, for the scenario where a non-AP STA intends to establish a P2P TWT schedule with its associated AP in order to indicate the non-AP STA's unavailability schedule, and negotiates with the AP to set up the P2P TWT schedule with the AP, if the unavailability mode indicated is a QoS-aware unavailability mode, then during the P2P TWT negotiation, if the non-AP STA includes one or more broadcast TWT IDs corresponding to R-TWT schedules in a QoS information element included in the channel usage request frame sent to the AP used for the P2P TWT negotiation, then it may indicate that the non-AP STA as a TXOP responder may not be available (e.g., may be in doze state) for receiving a frame during an R-TWT schedule that is not included in the R-TWT Info if the corresponding R-TWT SP overlaps with a P2P TWT SP corresponding to the P2P TWT schedule, as shown in FIG. 23.

FIG. 23 illustrates an example 2300 of STA availability for receiving a frame corresponding to an R-TWT SP listed in a QoS information element according to embodiments of the present disclosure. The embodiment of STA availability for receiving a frame corresponding to an R-TWT SP listed in a QoS information element of FIG. 23 is for illustration only. Different embodiments of STA availability for receiving a frame corresponding to an R-TWT SP listed in a QoS information element could be used without departing from the scope of this disclosure.

In the example of FIG. 23, AP1 and STA1 perform an unavailability schedule setup for P2P TWT, where STA1 transmits a channel usage request frame with one or more broadcast TWT IDs corresponding to R-TWT schedules in a QoS information element to AP1, and STA1 receives a channel usage response frame from AP1. The channel usage request frame may indicate that STA1 as a TXOP responder may not be available for receiving a frame during an R-TWT schedule that is not included in the R-TWT Info even if the frame reception overlaps with a P2P TWT SP corresponding to the P2P TWT schedule.

Although FIG. 23 illustrates an example 2300 of STA availability for receiving a frame corresponding to an R-TWT SP listed in a QoS information element, various changes may be made to FIG. 23. For example, various changes to unavailability times could be made, etc. according to particular needs.

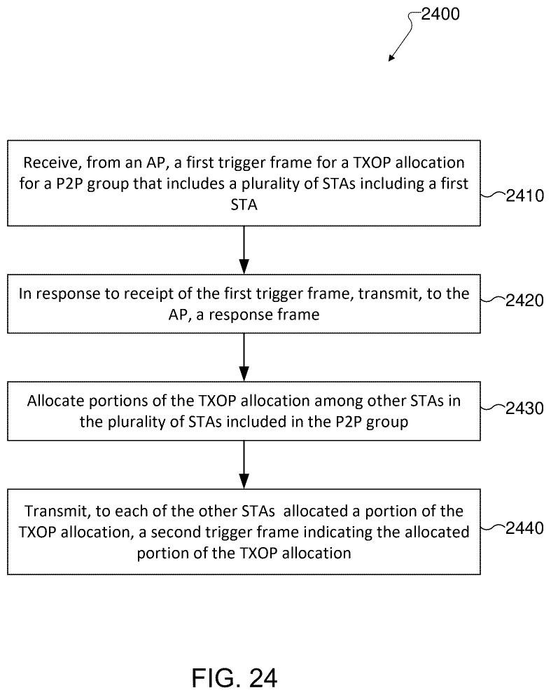

FIG. 24 illustrates an example method 2400 for leader-based TXOP redistribution in P2P communications according to embodiments of the present disclosure. An embodiment of the method illustrated in FIG. 24 is for illustration only. One or more of the components illustrated in FIG. 24 may be implemented in specialized circuitry configured to perform the noted functions or one or more of the components may be implemented by one or more processors executing instructions to perform the noted functions. Other embodiments of a method for leader-based TXOP redistribution in P2P communications could be used without departing from the scope of this disclosure.

In the example of FIG. 24, method 2400 begins at step 2410. At step 2410, a first STA (such as STA1 of FIG. 11) receives, from an AP (such as AP1 if FIG. 11), a first trigger frame for a TXOP allocation for a P2P group that includes a plurality of STAS including the first STA.

In some embodiments, the first trigger fame may include an indication that the TXOP allocation is for the P2P group. In some embodiments, the first trigger frame may be one of a broadcast frame and a multicast frame.

In some embodiments, the first trigger frame may be individually addressed to the first STA, and the first STA may be a P2P group leader of the P2P group.

In some embodiments, the first trigger frame may be individually addressed to the P2P group using a unique identifier, and the unique identifier may be included in the first trigger frame.

At step 2420, in response to receipt of the first trigger frame, the first STA transmits, to the AP, a response frame.

At step 2430, the first STA allocates portions of the TXOP allocation among other STAs in the plurality of STAs included in the P2P group.

At step 2440, the first STA transmits, to each of the other STAs allocated a portion of the TXOP allocation, a second trigger frame indicating the allocated portion of the TXOP allocation.

In some embodiments, the first STA may transmit, to the AP, as part of a P2P TWT negotiation, a channel usage request frame including an indication indicating a QoS-aware unavailability mode. The indication may be included in a QOS IE of the channel usage request frame. The QOS IE may further include R-TWT schedule information.

In some embodiments, the R-TWT schedule information may indicate that the first STA is available during a P2P TWT SP corresponding to a P2P TWT schedule when the P2P TWT SP overlaps with an R-TWT SP.

In some embodiments, the R-TWT schedule information may indicate that the first STA is available as a TXOP responder for receiving a frame during the R-TWT SP when reception of the frame overlaps with the P2P TWT SP corresponding to the P2P TWT schedule.

In some embodiments, the R-TWT SP may correspond to an R-TWT schedule in which the first STA is a member. The R-TWT schedule information may indicate that the first STA is unavailable as a TXOP responder for receiving a frame during a R-TWT SP that does not correspond with the R-TWT schedule when reception of the frame overlaps with a P2P TWT SP corresponding to the P2P TWT schedule.

In some embodiments, the R-TWT SP may correspond to an R-TWT schedule in which the first STA is a member, and the R-TWT schedule information may indicate that the first STA is available as a TXOP responder for receiving a frame during the R-TWT SP that corresponds with the R-TWT schedule when reception of the frame overlaps with the P2P TWT SP corresponding to the P2P TWT schedule.

Although FIG. 24 illustrates one example method 2400 for leader-based TXOP redistribution in P2P communications, various changes may be made to FIG. 24. For example, while shown as a series of steps, various steps in FIG. 24 could overlap, occur in parallel, occur in a different order, occur any number of times, be omitted, or replaced by other steps.

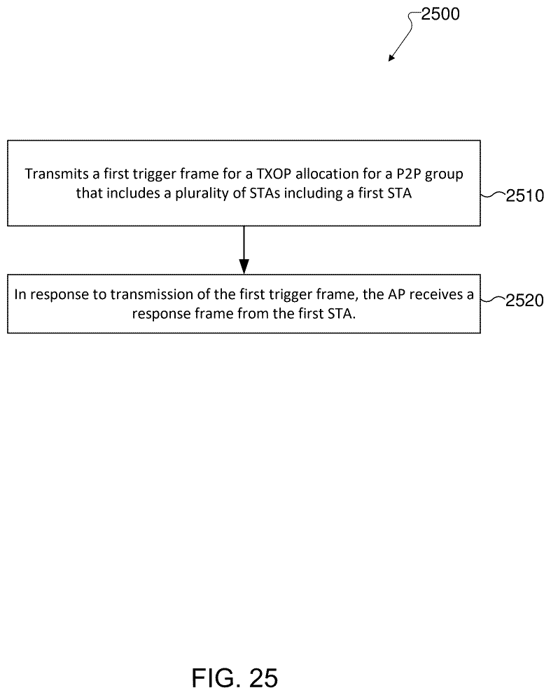

FIG. 25 illustrates another example method 2500 for leader-based TXOP redistribution in P2P communications according to embodiments of the present disclosure. An embodiment of the method illustrated in FIG. 25 is for illustration only. One or more of the components illustrated in FIG. 25 may be implemented in specialized circuitry configured to perform the noted functions or one or more of the components may be implemented by one or more processors executing instructions to perform the noted functions. Other embodiments of a method for leader-based TXOP redistribution in P2P communications could be used without departing from the scope of this disclosure.

In the example of FIG. 25, method 2500 begins at step 2510. At step 2510, an AP (such as AP1 of FIG. 11) transmits a first trigger frame for a TXOP allocation for a P2P group that includes a plurality of STAs including a first STA (such as STA1 of FIG. 11).

In some embodiments, the first trigger fame may include an indication that the TXOP allocation is for the P2P group. In some embodiments, the first trigger frame may be one of a broadcast frame and a multicast frame.

In some embodiments, the first trigger frame may be individually addressed to the first STA, and the first STA may be a P2P group leader of the P2P group.

In some embodiments, the first trigger frame may be individually addressed to the P2P group using a unique identifier, and the unique identifier may be included in the first trigger frame.

At step 2520, in response to transmission of the first trigger frame, the AP receives a response frame from the first STA.

In some embodiments, the AP may receive, from the first STA, as part of a P2P TWT negotiation, a channel usage request frame including an indication indicating a QoS-aware unavailability mode. The indication may be included in a QOS IE of the channel usage request frame. The QOS IE may further include R-TWT schedule information.

In some embodiments, the R-TWT schedule information may indicate that the first STA is available during a P2P TWT SP corresponding to a P2P TWT schedule when the P2P TWT SP overlaps with an R-TWT SP.

In some embodiments, the R-TWT schedule information may indicate that the first STA is available as a TXOP responder for receiving a frame during the R-TWT SP when reception of the frame overlaps with the P2P TWT SP corresponding to the P2P TWT schedule.

In some embodiments, the R-TWT SP may correspond to an R-TWT schedule in which the first STA is a member. The R-TWT schedule information may indicate that the first STA is unavailable as a TXOP responder for receiving a frame during a R-TWT SP that does not correspond with the R-TWT schedule when reception of the frame overlaps with a P2P TWT SP corresponding to the P2P TWT schedule.

In some embodiments, the R-TWT SP may correspond to an R-TWT schedule in which the first STA is a member, and the R-TWT schedule information may indicate that the first STA is available as a TXOP responder for receiving a frame during the R-TWT SP that corresponds with the R-TWT schedule when reception of the frame overlaps with the P2P TWT SP corresponding to the P2P TWT schedule.

Although FIG. 25 illustrates one example method 2500 for leader-based TXOP redistribution in P2P communications, various changes may be made to FIG. 25. For example, while shown as a series of steps, various steps in FIG. 25 could overlap, occur in parallel, occur in a different order, occur any number of times, be omitted, or replaced by other steps.

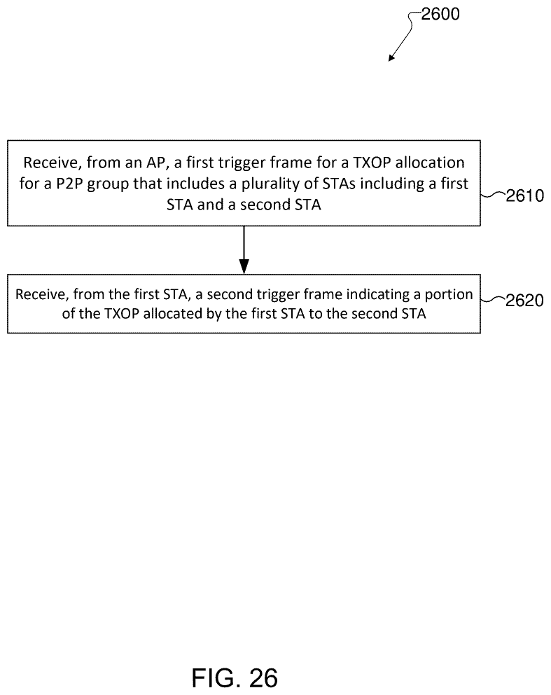

FIG. 26 illustrates an example method 2600 for leader-based TXOP redistribution in P2P communications according to embodiments of the present disclosure. An embodiment of the method illustrated in FIG. 26 is for illustration only. One or more of the components illustrated in FIG. 26 may be implemented in specialized circuitry configured to perform the noted functions or one or more of the components may be implemented by one or more processors executing instructions to perform the noted functions. Other embodiments of a method for leader-based TXOP redistribution in P2P communications could be used without departing from the scope of this disclosure.

In the example of FIG. 26, method 2600 begins at step 2610. At step 2610, a second STA (such as STA2 of FIG. 11) receives, from an AP (such as AP1 if FIG. 11), a first trigger frame for a TXOP allocation for a P2P group that includes a plurality of STAS including a first STA and the second STA.

In some embodiments, the first trigger fame may include an indication that the TXOP allocation is for the P2P group. In some embodiments, the first trigger frame may be one of a broadcast frame and a multicast frame.

In some embodiments, the first trigger frame may be individually addressed to the first STA, and the first STA may be a P2P group leader of the P2P group.

In some embodiments, the first trigger frame may be individually addressed to the P2P group using a unique identifier, and the unique identifier may be included in the first trigger frame.

At step 2620, the second STA receives, from the first STA, a second trigger frame indicating a portion of the TXOP allocated by the first STA to the second STA.

Although FIG. 26 illustrates one example method 2600 for leader-based TXOP redistribution in P2P communications, various changes may be made to FIG. 26. For example, while shown as a series of steps, various steps in FIG. 26 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A first station (STA) comprising:
a transceiver configured to:
receive, from an access point (AP), a first trigger frame for a transmission opportunity (TXOP) allocation for a peer-to-peer (P2P) group that includes a plurality of STAs including the first STA; and
in response to receipt of the first trigger frame, transmit, to the AP, a response frame; and
a processor operably coupled to the transceiver, the processor configured to allocate portions of the TXOP allocation among other STAs in the plurality of STAs included in the P2P group,
wherein the transceiver is further configured to transmit, to each of the other STAs allocated a portion of the TXOP allocation, a second trigger frame indicating the allocated portion of the TXOP allocation.

2. The first STA of claim 1, wherein the first trigger frame includes an indication that the TXOP allocation is for the P2P group.

3. The first STA of claim 2, wherein the first trigger frame is one of a broadcast frame and a multicast frame.

4. The first STA of claim 2, wherein:
the first trigger frame is individually addressed to the first STA; and
the first STA is a P2P group leader of the P2P group.

5. The first STA of claim 2, wherein the first trigger frame is individually addressed to the P2P group using a unique identifier,
wherein the unique identifier is included in the first trigger frame.

6. The first STA of claim 1, wherein:
the transceiver is further configured to transmit, to the AP, as part of a P2P target wake time (TWT) negotiation, a channel usage request frame including an indication indicating a quality of service (QOS)-aware unavailability mode, and
the indication is included in a QoS information element (IE) of the channel usage request frame, the QoS IE further including restricted TWT (R-TWT) schedule information.

7. The first STA of claim 6, wherein the R-TWT schedule information indicates that the first STA is available during a P2P TWT service period (SP) corresponding to a P2P TWT schedule when the P2P TWT SP overlaps with an R-TWT SP.

8. The first STA of claim 7, wherein the R-TWT schedule information indicates that the first STA is available as a TXOP responder for receiving a frame during the R-TWT SP when reception of the frame overlaps with the P2P TWT SP corresponding to the P2P TWT schedule.

9. The first STA of claim 7, wherein:
the R-TWT SP corresponds to an R-TWT schedule in which the first STA is a member; and
the R-TWT schedule information indicates that the first STA is unavailable as a TXOP responder for receiving a frame during a R-TWT SP that does not correspond with the R-TWT schedule when reception of the frame overlaps with a P2P TWT SP corresponding to the P2P TWT schedule.

10. The first STA of claim 7, wherein:
the R-TWT SP corresponds to an R-TWT schedule in which the first STA is a member; and
the R-TWT schedule information indicates that the first STA is available as a TXOP responder for receiving a frame during the R-TWT SP that corresponds with the R-TWT schedule when reception of the frame overlaps with the P2P TWT SP corresponding to the P2P TWT schedule.

11. An access point (AP) comprising:
a processor; and
a transceiver operably coupled to the processor, the transceiver configured to:
transmit a first trigger frame for a transmission opportunity (TXOP) allocation for a peer-to-peer (P2P) group that includes a plurality of STAs including a first STA; and
in response to transmission of the first trigger frame, receive a response frame from the first STA.

12. The AP of claim 11, wherein the first trigger frame (i) is one of a broadcast frame and a multicast frame and (ii) includes an indication that the TXOP allocation is for the P2P group.

13. The AP of claim 12, wherein:
the first trigger frame is individually addressed to the first STA; and
the first STA is a P2P group leader of the P2P group.

14. The AP of claim 12, wherein the first trigger frame is individually addressed to the P2P group using a unique identifier,
wherein the unique identifier is included in the first trigger frame.

15. The AP of claim 11, wherein:
the transceiver is further configured to receive, from the first STA, as part of a P2P target wake time (TWT) negotiation, a channel usage request frame including an indication indicating a quality of service (QOS)-aware unavailability mode, and
the indication is included in a QoS information element (IE) of the channel usage request frame, the QoS IE further including restricted TWT (R-TWT) schedule information.

16. The AP of claim 15, wherein the R-TWT schedule information indicates that the first STA is available during a P2P TWT service period (SP) corresponding to a P2P TWT schedule when the P2P TWT SP overlaps with an R-TWT SP.

17. The AP of claim 16, wherein the R-TWT schedule information indicates that the first STA is available as a TXOP responder for receiving a frame during the R-TWT SP when reception of the frame overlaps with the P2P TWT SP corresponding to the P2P TWT schedule.

18. The AP of claim 16, wherein:
the R-TWT SP corresponds to an R-TWT schedule in which the first STA is a member; and
the R-TWT schedule information indicates that the first STA is unavailable as a TXOP responder for receiving a frame during a R-TWT SP that does not correspond with the R-TWT schedule when reception of the frame overlaps with a P2P TWT SP corresponding to the P2P TWT schedule.

19. The AP of claim 16, wherein:
the R-TWT SP corresponds to an R-TWT schedule in which the first STA is a member; and
the R-TWT schedule information indicates that the first STA is available as a TXOP responder for receiving a frame during the R-TWT SP that corresponds with the R-TWT schedule when reception of the frame overlaps with the P2P TWT SP corresponding to the P2P TWT schedule.

20. A second station (STA) comprising:
a processor, and
a transceiver operably coupled to the processor, the transceiver configured to:
receive, from an access point (AP), a first trigger frame for a transmission opportunity (TXOP) allocation for a peer-to-peer (P2P) group that includes a plurality of STAs including a first STA and the second STA; and
receive, from the first STA, a second trigger frame indicating a portion of the TXOP allocated by the first STA to the second STA.
